(19) United States
(12) Patent Application Publication
(10) Pub. No.: US 2005/0131576 A1
(43) Pub. Date: Jun. 16, 2005

(54) Mail delivery support system

(76) Inventors: Guido De Leo, Genova (IT); Maria Teresa Mainini, Genova (IT)

Correspondence Address: LINIAK, BERENATO & WHITE, Suite 240, 6550 Rock Spring Drive, Bethesda, MD, 20817, US

(21) Appl. No.: 10/976,023

(22) Filed: Oct. 29, 2004

(30) Foreign Application Priority Data
Oct. 31, 2003 (IT) TO2003A000859

(51) Int. Cl. G06F 7/00

(52) U.S. Cl. 700/223; 700/217

(57) ABSTRACT

A mail delivery support system including a central station communicating and exchanging data with a mail sorting system; a number of peripheral units housed in respective mobile vehicles; and a telecommunications link between the central station and the peripheral units. Each peripheral unit supplies a user with sequential information concerning a number of successive delivery points along a delivery route along which to deposit and deliver mail processed by the mail sorting system

The present invention relates to a mail delivery support system.

### BACKGROUND OF THE INVENTION

As is known, mail is delivered by a carrier, who collects a number of mail items (in particular, packaged items in containers), loads them onto a transport vehicle (e.g. a van), drives the vehicle along a delivery route, and stops at successive delivery points along the route to deliver the mail.

The carrier is therefore required to perform various functions: drive the vehicle, locate the next delivery point to which mail is addressed, sort out and check the mail for delivery, actually deliver the mail, and perform any additional related functions, such as obtaining signatures for registered mail. Such a work load obviously calls for a good deal of care and concentration. To save time, the carrier may overlap certain functions, thus endangering his own safety and that of other road users, or may perform functions in series, which, however, reduces efficiency and causes traffic holdups, particularly in crowded city areas.

### SUMMARY OF THE INVENTION

It is an object of the present invention to provide a mail delivery support system designed to make the carrier's job easier.

According to the present invention, there is provided a mail delivery support system, characterized by comprising: at least one central station communicating and exchanging data with a mail sorting system; a number of mobile peripheral units, in particular, peripheral units housable in respective vehicles; and a link connecting said central station to said peripheral units; each peripheral unit having a central processing unit receiving data transmitted by the central station over said link, and processing and video display means for supplying a user with information about a number of successive delivery points along a delivery route for mail processed by said mail sorting system.

Delivery data is thus transmitted punctually to the carrier, who can concentrate on driving the vehicle, thus greatly increasing his own and other road users' safety. Moreover, since all the essential delivery data (items for delivery, additional functions, delivery routes and points) are supplied directly and automatically by the central station, the carrier no longer wastes time sorting out delivery details, thus greatly improving the reliability and efficiency of the service.

### BRIEF DESCRIPTION OF THE DRAWINGS

A preferred, non-limiting embodiment of the invention will be described by way of example with reference to the accompanying drawings, in which:

FIG. 1 shows, schematically, a mail delivery support system in accordance with the teachings of the present invention;

FIG. 2 shows a detail of the FIG. 1 system;

FIG. 3 shows a flow chart of operations performed by the system according to the present invention.

### DETAILED DESCRIPTION OF THE INVENTION

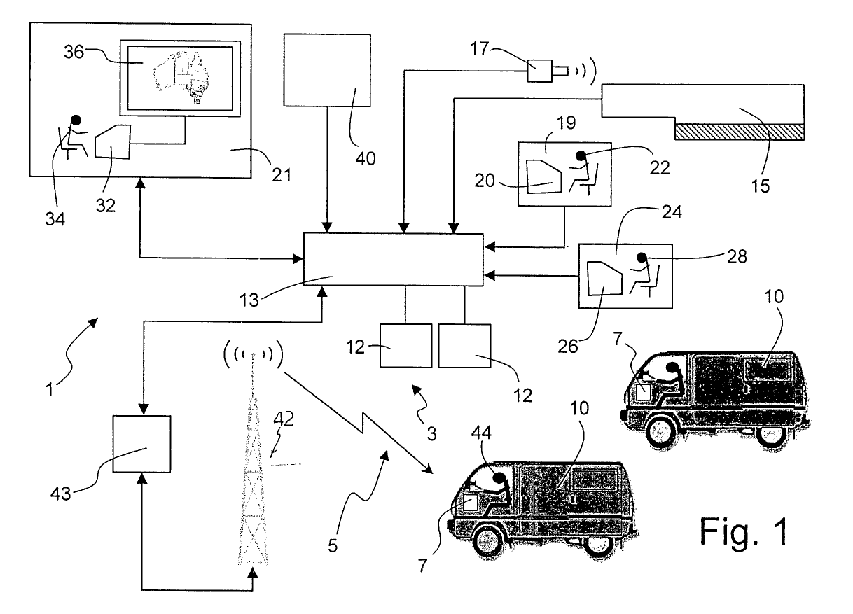

Number 1 in FIG. 1 indicates as a whole a mail delivery support system.

System 1 comprises a central station 3 communicating over a telecommunications link, e.g. a two-way radio relay system 5 or cellular telephone technology (e.g. GPRS, GSM, UMTS) link, with a number of peripheral units 7 housed in respective vehicles, in particular vans, 10.

Central station 3 comprises a number of processing units 12 communicating with one another over one or more common data lines (BUSES) 13. Processing units 12 communicate and exchange data with a number of bodies, including:
a mail sorting system 15 for sorting, for example, ordinary mail and supplying groups of mail items divided according to successive delivery points along a delivery route of a carrier;
an image acquisition system 17 for acquiring a digital image of the mail items and/or groups of mail items sorted by system 15;
a route planning system 19, which transmits planning data to data line 13, and in which a computerized unit 20, controlled by one or more planning operators 22, defines one or more of the following:
   mail delivery routes;
   approach routes to reach the delivery route and return routes at the end of the delivery route;
   connecting routes between a mail depot and receiving offices;
   routes between receiving offices and delivery routes.
a traffic monitoring system 24, which transmits road traffic data to data line 13, and in which a computerized unit 26, controlled by one or more operators 28, monitors road traffic conditions in the area comprising central station 3 and the mail delivery routes;
a monitoring system 21, in which a computerized unit 32, controlled by one or more operators 34, supervises operation of central station 3 as a whole monitoring system 21 is conveniently equipped with wall monitors 36 for displaying information to operator 34;
a number of external, e.g. traffic information, providers 40 communicating with data line 13.

Provision may also be made to connect common data line 13 to a call centre (not shown) for receiving user service (or service change) requests.

More specifically, Route planning system 19 defines delivery routes; for which purpose, system 19 may comprise a tool allowing access by operator 22 to an interface graphically defining a given portion of territory. The tool allows the operator to map out a broken line representing the route and enabling the operator to determine the delivery points and any additional points required to define the route correctly. To each mapped delivery point, the operator assigns the relative postal code and the time taken to reach the delivery point from the previous delivery point. At the end of the above operations, operator 22 may save the route together with a relative code.

Operator 22 may also access statistical load and travel time data relative to a given route or all the routes as a whole. This function provides for determining critical routes, i.e. with an above-average load and/or travel time, and so enables planning operator 22 to determine the nature of the anomaly and work out possible solutions.

Monitoring system 21 provides for monitoring the service and for communicating directly with operators 44 in vehicles 10 to transmit the following information over telecommunications link 5:
anomalous situations (e.g. wrong routes, prolonged stops, serious delays with respect to set schedules, etc.); and
critical traffic situations (heavy traffic, traffic jams, road blocks).

System 21 also responds to problem messages from operators 44 (breakdowns, accidents, sickness, etc.).

Communication may be vocal or by dedicated messages.

Monitor 36 may indicate various information, including:
location of vehicles 10 along delivery routes;
traffic conditions in the mail delivery area.

Displaying the location of peripheral units 7 along the delivery routes, by means of colour-coded icons representing the vehicles, is especially useful in determining critical situations (delays, need to communicate with the central station, breakdowns, etc.) and so enabling immediate intervention.

Central station 3 comprises a transmitting-receiving radio station 42 connected by an interface 43 to data line 13 to send/receive digital data packages to and from peripheral units 7. Radio station 42 also ensures two-way sound connection between operators 22, 28, 34 at central station 3 and operators 44 in vehicles 10. Obviously, in the event telecommunications link 5 is based on cellular telephone (GSM, GPRS, UMTS) technology, the radio station is replaced with the appropriate (known) equipment.

Sorting system 15 typically comprises a number of sorting units (not shown) for sorting mail of one or more types, and, by means of image acquisition system 17, also supplies digital images of the sequenced outgoing mail.

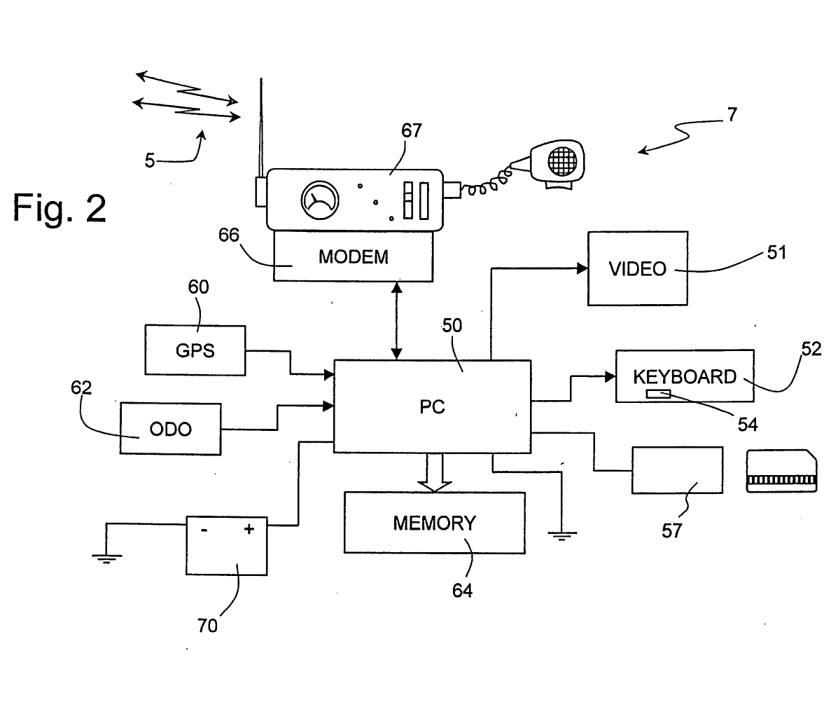

FIG. 2 shows a detail of a peripheral unit 7.

Peripheral unit 7 comprises a central processing unit conveniently defined by a particularly robust personal computer 50 with a video terminal 51 (e.g. a backlighted liquid-crystal colour video) and an alphanumeric keyboard 52, which may conveniently comprise a buzzer 54 and predetermined function keys.

Central unit 50 is connected over a serial line to a magnetic or smart card reader or biometric scanner 57 used as explained later on.

Central unit 50 is also connected over respective serial lines to a GPS unit 60 and optional odometer 62, and has an expanded (e.g. optical-media-based) memory 64 storing a number of digital maps.

Central unit 50 may communicate with a cellular telephone (GSM, GPRS, UMTS) system to integrate data and voice communication.

Data connection to the radio communication medium (radio relay or cellular telephone system) is by a modem 66 connected over a serial line to personal computer 50 and cooperating with a transmitting-receiving device 67.

Transmitting-receiving device 67 also provides for two-way sound connection to central station 3.

Peripheral unit 7 may be powered by the battery 70 of vehicle 10.

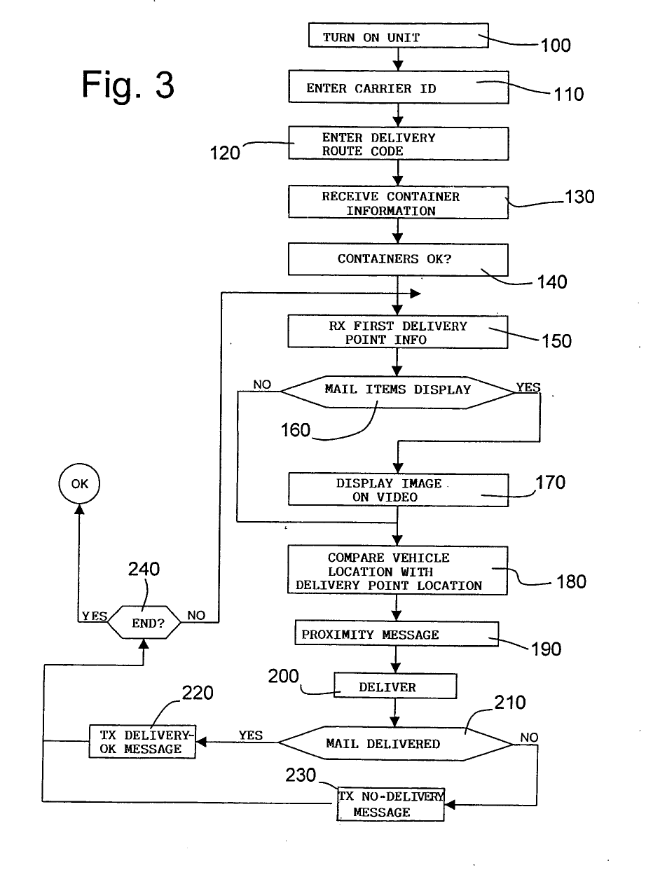

The operations performed by peripheral units 7 of system 1 will be described with particular reference to FIG. 3.

When peripheral unit 7 is turned on (block 100), a block 110 waits for identification of the user 44 (hereinafter referred to as the carrier). Such identification is acquired automatically by reading the biometric characteristics of the carrier or a magnetic or smart card inserted by carrier 44 into card reader 57. Block 110 is followed by a block 120, which waits for an alphanumeric code indicating a specific delivery route assigned to carrier 44. When the route code is entered correctly by carrier 44, block 120 goes on to a block 130.

Block 130 is supplied over telecommunications link 5 with information about the mail items to be delivered along the specific route selected in block 120; which information has been generated by sorting system 15 and transmitted to data line 13, where it has been processed by monitoring system 21.

More specifically, block 130 receives information about the number and characteristics of the containers containing the mail items to be delivered along the route of that particular carrier; which information is stored in the buffer memory of personal computer 50 and displayed on video 51.

Block 130 is followed by a block 140, which waits for a manual command (e.g. entered on keyboard 52) by carrier 44 confirming the container information on video 51 corresponds with the actual containers in vehicle 10.

On receiving confirmation, block 140 goes on to a block 150, which is supplied over telecommunications link 5 with information about the first delivery point to which one or more mail items are to be delivered. This information has been generated in central station 3 by combining the information from sorting system 15 with the information generated by route planning system 19, and may be displayed on video 51, e.g. by a digital map graphically showing the delivery route, the area surrounding the delivery route, and the delivery point along the route. Block 150 also supplies information about the number and type of mail items to be delivered at the next delivery point.

Block 150 is followed by a block 160, which may request display of an image of the mail items for delivery.

If so, block 160 is followed by a block 170, which shows carrier 44 a digital image on the video (in background mode) of the mail item/s for delivery at the next delivery point.

The image, acquired by image acquisition system 17, has been transmitted over telecommunications link 5. Block 170 and block 160 (if no image is requested or available) are followed by a block 180, which compares the location of vehicle 10 (detected by GPS 60 and optional odometer 62) with the location of the next delivery point to determine approach of vehicle 10 to the delivery point.

Mail display may be conducted differently from the method described with reference to blocks 160 and 170, e.g. by initially entering (e.g. when personal computer 50 is turned on) various options, such as:
permanent background display of mail image;
display mail image by request.

The display itself may be executed in various ways, including:
background image display with superimposed delivery point information in text form;
alternative image and text-form information display;
cyclic function key selection: text only/image only/superimposed.

Provision may also be made for displaying more than one next delivery point, e.g. the next two or three, to give the carrier a wider picture of the next deliveries.

When the distance between the detected vehicle location and the location of the next delivery point is below a given threshold, block 180 goes on to a block 190, which activates an audio-visual message (e.g. a message displayed on video 51 and accompanied by sounding buzzer 54) to alert carrier 44 of arrival at the next delivery point. Block 190 is followed by a standby block 200, which awaits actual delivery of the mail item/s at the delivery point reached.

Block 200 is followed by a block 210, which waits for a manual command by carrier 44 confirming delivery.

Block 210 may interpret carrier 44 pulling away from the delivery point as a signal confirming delivery.

Block 210, requested at the initial configuration stage, may even be eliminated.

Carrier 44 may enter a command confirming delivery on keyboard 52; in which case, block 210 goes on to a block 220, which transmits a mail delivery confirmation message over telecommunications link 5 to central station 3, which, in response to the message, transmits information relative to the mail item/s to be delivered at the next delivery point.

Carrier 44 may even enter a no-delivery command on keyboard 52; in which case, block 210 goes on to a block 230, which memorizes and/or transmits a no-delivery message (over radio relay system 5) to central station 3, which, in response to the message, logs the non-delivery and supplies information relative to the mail items/s to be delivered at the next delivery point.

Both blocks 220 and 230 are followed by a block 240, which waits for an end-of-delivery information which terminates the operating sequence; conversely, block 240 goes back to block 150.

In actual use, when coming on duty, carrier 44 first identifies himself (block 110) and selects the route to be worked (block 120) by pressing a delivery-round-start function key and either inserting a badge, defined by a magnetic, proximity, or smart card, into reader 57 or undergoing a biometric scan. Once this is done, the system requests carrier 44 to enter the route code defined by a sequence of alphanumeric keys.

In response to the route code, the system transmits and displays a list of the containers assigned to that particular route (block 130); and, after checking the list corresponds to what is actually loaded on the vehicle (block 140), carrier 44 enters a confirm message.

By pressing a given function key (block 160), carrier 44 may also request a background image of the mail items in the containers to assist in checking the load.

As stated, carrier 44 may also choose between “request/background/multiple” display modes.

Once the container list is checked, the system transmits the first address (block 150) to carrier 44, with the number and type of items for delivery in the foreground, and a background image of the bundle for delivery.

On approaching the delivery point (blocks 180 and 190), the carrier is informed on the next delivery point.

Once the mail is delivered, carrier 44 confirms delivery by pressing a given key or by simply pulling away from the delivery point.

At this point, the system indicates the next delivery point, and operation continues in the same way until all the mail is delivered.

Any system-detected delays with respect to schedule are shown on the screen.

On completing the round, the carrier reports to the system the end of the round; this operation disables the terminal until it is activated again.

Some of the mail items through system 15 may call for manual processing and therefore be out of sequence; in which case, central station 3 signals the presence of manually sequenced or unaddressed items, i.e. items to be delivered indiscriminately to all delivery points.

Central station 3 may also transmit additional information to peripheral units 7, e.g. relating to additional functions to be performed at given delivery points.

Such information may include, for example
delivering registered/insured mail which must be signed for;
delivering mail to be paid for on delivery by the user; and
picking up mail at the user.

The advantages of the system according to the present invention will be clear from the foregoing description. In particular, the system provides for:
on-round assistance of carriers, by supplying information relative to the delivery and duties to be executed, delivery routes, and delivery points along the routes;
integrating mail delivery with the sorting process to enable use of information available at the sorting stage;
automatically defining delivery routes, and downloading the relative delivery data automatically to the vehicles;
providing the carrier with an assigned container list, which can be checked against the containers actually loaded on the vehicle;
information gathering concerning delivery, thus enabling the carrier to report immediately any problems preventing delivery;
round monitoring from a central station, by monitoring vehicle locations and delivery progress;
delivery time statistics gathering, so that delivery points can be redistributed evenly over new routes according to available resources.

What is more, the delivery support system according to the present invention performs the above functions with no need for additional mail delivery coding (system 1 provides, for example, for sorting ordinary mail).

Clearly, changes may be made to the system as described herein without, however, departing from the scope of the present invention.

For example, telecommunications link 5 may be replaced by a direct link for full data transfer to peripheral units 7 in a data loading step.

The direct link may be made in various ways, including:
direct cable link;
short-range radio link, e.g. infrared-ray or public-frequency link (Wireless, Ethernet std IEEE 802.11, Blue Tooth, etc.).

In this case, there would be no on-round data flow from peripheral units 7 to central station 3, e.g. to permit location of the peripheral units. The potential of such a system is obviously reduced, by permitting no online interaction between carrier 44 and central station 3. Information concerning the mail to be delivered is still made available to carriers, by being downloaded to peripheral units 7; and information concerning delivery may be downloaded from peripheral units 7 to central station 3 over a subsequent direct link (e.g. cable or short-range radio link) upon return of carrier 44 to central station 3 at the end of the round.

1) A mail delivery support system, characterized by comprising:
at least one central station (3) communicating and exchanging data with a mail sorting system (15);
a number of mobile peripheral units (7), in particular, peripheral units housable in respective vehicles (10); and
a link (5) connecting said central station (3) to said peripheral units;
each peripheral unit having a central processing unit (50) receiving data transmitted by the central station over said link (5), and processing and video display means (51, 150) for supplying a user (44) with information about a number of successive delivery points along a delivery route for mail processed by said mail sorting system (15).

2) A system as claimed in claim 1, wherein said link is a telecommunications link.

3) A system as claimed in claim 2, wherein said telecommunications link comprises one of the following communication means:
a two-way radio relay system (5);
a cellular telephone technology (e.g. GPRS, GSM, UMTS) link.

4) A system as claimed in claim 2, wherein said central processing unit (50) comprises route selecting means (120, 130) which respond to a user command, and which, following data exchange with the central station over said telecommunications link (5), supply (130) information concerning the mail to be delivered along the specific route selected by the user.

5) A system as claimed in claim 4, wherein said route selecting means (120, 130) supply the user with information concerning the number and characteristics of the containers containing the mail to be delivered along the selected delivery route.

6) A system as claimed in claim 4, wherein said route selecting means (120, 130) are followed by confirmation standby means (140), which await a user command issued when the container information supplied to the user (44) matches the actual characteristics of the containers physically assigned to the user.

7) A system as claimed in claim 1, wherein said processing and video display means (51, 150) supply a graphic display of said delivery route, of the area surrounding the delivery route, and of the delivery points along the delivery route.

8) A system as claimed in claim 1, wherein said peripheral unit comprises image display means (170) selectable (160) by the user and for displaying a digital image of the mail item/s for delivery.

9) A system as claimed in claim 1, wherein additional-user-function display means are provided, which exchange data with said central station, and display one or more of the following on said processing and video display means (51, 150):
information concerning mail not sorted in the usual manner;
information concerning registered/insured mail requiring a receipt;
information concerning mail to be paid for on delivery;
information concerning mail to be picked up at a delivery point.

10) A system as claimed in claim 1, wherein positioning means (180, 190) are provided, which compare the detected location of said peripheral unit with the location of the current delivery point; said positioning means (180, 190) emitting proximity messages when the detected location of the peripheral unit approaches the location of the current delivery point.

11) A system as claimed in claim 1, wherein delivery confirmation means (210, 220) are provided, which respond to a mail-delivered signal; said delivery confirmation means (210, 220) supervising storage or transmission to the central station (3), over the telecommunications link (5), of a mail-delivered message; said central station (3) responding to said mail-delivered message by supplying information concerning the mail item/s to be delivered to the next delivery point.

12) A system as claimed in claim 2, wherein said central station comprises a route planning system (19), wherein a computerized unit (20), controlled by an operator (22), defines one or more of the following:
mail delivery routes;
approach routes to reach the delivery route and return routes at the end of the delivery route;
connecting routes between a mail depot and receiving offices;
routes between receiving offices and delivery routes.

13) A system as claimed in claim 2, wherein said central station comprises a link to a traffic monitoring system (24), in which a computerized unit (26), controlled by an operator (28), monitors road traffic conditions in the area comprising mail delivery routes.

14) A system as claimed in claim 2, wherein said central station comprises a monitoring system (21), in which a computerized unit (32), controlled by an operator (34), supervises operation of the central station (3).

15) A system as claimed in claim 2, wherein said central processing unit (50) cooperates with positioning means (60, 62) for determining the location of the peripheral units (7) within a given area; said central processing unit (50) operating and exchanging data, over said telecommunications link (5), with said central station (3) to supply, at said central station (3), information concerning the location of said peripheral units (7) along at least one delivery route.

16) A system as claimed in claim 1, wherein said sorting system (15) comprises an image acquisition system (17) for acquiring a digital image of the mail items and/or groups of mail items sorted by said sorting system (15).

17) A system as claimed in claim 1, wherein said sorting system (15) sorts ordinary mail.
